(19) United States
(12) Patent Application Publication
(10) Pub. No.: US 2020/0361368 A1
(43) Pub. Date: Nov. 19, 2020

(54) SITUATION NOTIFICATION APPARATUS HAVING SILENT NOTIFICATION MODE FUNCTION WITH ENHANCED NOTICEABILITY AND VISIBILITY, AND TRANSPORTATION MEANS COMPRISING SAME

(71) Applicant: Kyu Yun LIM, Jeungpyeong-gun (KR)

(72) Inventor: Kyu Yun LIM, Jeungpyeong-gun (KR)

(21) Appl. No.: 16/959,773

(22) PCT Filed: Feb. 13, 2018
(86) PCT No.: PCT/KR2018/001873

§ 371 Date: Jul. 2, 2020

(30) Foreign Application Priority Data
Jan. 31, 2018 (KR) 10-2018-0011786

(51) Int. Cl. B60Q 1/50; B60Q 1/00; B60Q 1/26; B60Q 5/00

(52) U.S. Cl. CPC B60Q 1/50; B60Q 1/0023; B60Q 2300/45; B60Q 5/00; B60Q 2400/50; B60Q 1/2603

(57) ABSTRACT

Disclosed are a situation notification apparatus and a transportation means comprising same, wherein the situation notification apparatus, which is mounted in a transportation means and emits light such that the presence of the transportation means is notified to the periphery thereof, comprises: an image projection means configured to project an image onto the ground on the periphery of the transportation means; a memory unit in which a plurality of images are stored; and a microcomputer for controlling the image projection means and the memory unit such that at least one image among the plurality of images is projected onto the ground on the periphery of the transportation means.

### TECHNICAL FIELD

The present invention relates to a situation notification apparatus having a silent notification mode function with enhanced noticeability and visibility, and a transportation means having the same.

### BACKGROUND ART

In general, drivers are required to use vehicle horns to call attention to hazards in order to prevent traffic accidents, such as crashes between vehicles and collisions between a pedestrians and a vehicle.

However, such vehicle horns cause noise pollution, and thus cause stress to pedestrians or drivers of other vehicles, and sometimes become a factor that aggravates traffic accidents. In particular, the imprudent use of vehicle horns is a major cause of both urban noise pollution and conflicts between drivers. Since the use of vehicle horns is irregular and unpredictable and is performed regardless of place and time, it is difficult to impose legal sanctions against the imprudent use of vehicle horns.

Therefore, it is necessary to alert drivers to the imprudent use of vehicle horns. Recently, although the use of vehicle horns has been considered to be a cause of noise pollution, legal sanctions have been imposed on vehicles which generate vehicle horn sounds higher than a prescribed level, and efforts have been made to suppress the imprudent use of vehicle horns through the self-awareness of drivers as much as possible, noise pollution attributable to the use of vehicle horns has not yet been satisfactorily resolved.

As described above, the use of the vehicle horn on a byroad or a well-traveled road gives an unpleasant feeling to a counterpart, and may actually cause an accident

Meanwhile, even though a driver sounds a horn, a person who is listening to music loudly while wearing earphones, or a person with a hearing impairment may not be aware of the vehicle's proximity. In addition, even in a noisy construction site, pedestrians or workers may not be aware that the heavy equipment is passing by, whereby there is a concern that the workers and the pedestrians may be involved in an accident.

### DISCLOSURE

### Technical Problem

A main objective of the present invention is to provide a situation notification apparatus that can project a step aside-indicating image on the ground in front of a pedestrian, rather than making vehicle horn sounds that may provoke anger, when a driver alerts pedestrians walking in, particularly, residential areas, during driving a vehicle.

In addition, the present invention is to provide a situation notification apparatus that simultaneously provides electronic sound and image projection, which facilitate awareness of transportation means such as heavy equipment even in a noisy construction site.

Meanwhile, a secondary objective of the present invention is to provide a transportation means equipped with a situation notification apparatus, which is capable of controlling the brightness of a vehicle's lighting unit, in order to prevent decreases in the visibility of the image projected onto the ground due to the lighting unit (such as headlight), when the situation notification apparatus installed in a vehicle is operated.

### Technical Solution

The main objective of the present invention may be achieved by a situation notification apparatus, which is mounted in a transportation means to emit light such that the presence of the transportation means is notified to the periphery thereof, the apparatus including an image projection means configured to project an image onto the ground on the periphery of the transportation means; a memory unit in which a plurality of images are stored; and a microcomputer controlling the image projection means and the memory unit such that at least one image among the plurality of images is projected onto the ground on the periphery of the transportation means.

Alternatively, the main objective may be achieved by a situation notification apparatus, which is mounted in a transportation means to provide electronic sound, light, or electronic sound and light such that the presence of the transportation means is notified to the periphery thereof, the apparatus including an electronic horn generating the electronic sound on the periphery of the transportation means; an image projection means configured to project an image onto the ground on the periphery of the transportation means; a memory unit in which a plurality of images are stored; and a microcomputer controlling the image projection means and the memory unit such that at least one image among the plurality of images is projected onto the ground on the periphery of the transportation means or controlling the image projection means, the memory unit, and the electronic horn such that at least one image and the electronic sound are output.

Meanwhile, the secondary objective may be achieved by a transportation means including a body of a transportation means; at least one situation notification apparatus according claim 1 or claim 2 mounted on the body of the transportation means; a lighting unit mounted in the body of the transportation means to emit light; and a control unit controlling a brightness of the lighting unit, in order to secure noticeability and visibility of an image when the situation notification apparatus is operated.

Herein, the transportation means may further include a sensor installed in all sides of the body to detect an object around the body, wherein the situation notification apparatus is configured so that a front situation notification apparatus that allows the image to be projected in front of the body and a rear situation notification apparatus that allows the image to be projected behind the body are installed at front and rear portions of the body, respectively, and the control unit tracks the object around the body through the sensor when image projection is performed by the front situation notification apparatus, and then operates the rear situation notification apparatus when the object is detected in the rear portion of the body.

### Advantageous Effects

According to the present invention, it is possible to project a step aside-indicating image on the ground in front of a pedestrian walking in, particularly, a residential area, and thus politely alert the pedestrian to step aside without surprising him/her.

In addition, even in a noisy construction site, it is possible to provide image projection (light, or image, etc.) simultaneously with the electronic sound, thereby facilitating the awareness of transportation means such as heavy equipment.

In addition, according to the present invention, the brightness of a vehicle's lighting unit (such as headlight) is controlled to prevent decreases in the visibility of an image projected on the ground by the lighting unit, when the situation notification apparatus installed in a vehicle is operated.

In addition, in the case that the pedestrian steps aside by the operation of the situation notification apparatus, when the sensor detects the pedestrian is located behind the vehicle, it is possible to respond to the stepping-aside pedestrian by projecting a thank you-indicating image automatically behind the vehicle. Therefore, it is possible to enable the driver to express his/her thanks to the pedestrian, and to make the pedestrian friendly to the operation of such a system.

### DESCRIPTION OF DRAWINGS

FIG. 1 is a block diagram showing an example of the configuration of a situation notification apparatus according to the present invention;

FIG. 2 is a block diagram showing another example of the configuration of a situation notification apparatus according to the present invention;

FIG. 3 is a block diagram showing an example of the configuration of a transportation means to which the situation notification apparatus of FIG. 1 is applied;

FIG. 4 is a block diagram showing another example of the configuration of the transportation means to which the situation notification apparatus of FIG. 1 is applied;

FIG. 5 is a view showing an example of a transportation means to which the situation notification apparatus according to the present invention is applicable; and

FIGS. 6 to 10 are views showing the operational relationship of a transportation means to which the situation notification apparatus according to the present invention is applied.

### MODE FOR INVENTION

The present invention can be applied to a variety of transformations and may have various embodiments, and specific embodiments will be illustrated in the drawings and described in detail in the detailed description. Effects and features of the present invention and methods for achieving them will be clarified with reference to embodiments described below in detail with reference to the drawings. However, the present invention is not limited to the embodiments disclosed below, but may be implemented in various forms.

Hereinafter, exemplary embodiments of the present invention will be described in detail with reference to the accompanying drawings, and the same or corresponding components will be given the same reference numerals when describing with reference to the drawings, and redundant description thereof will be omitted.

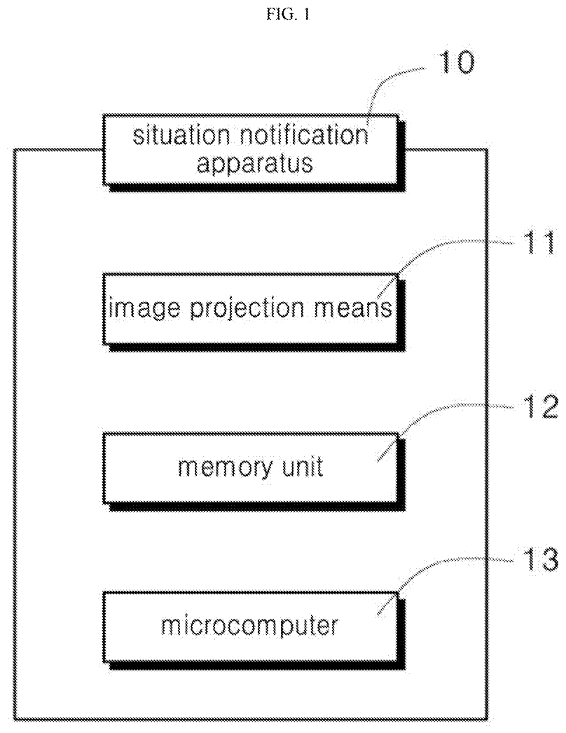

Referring to FIG. 1, a situation notification apparatus 10 according to the present invention is configured to be installed in a transportation means to emit light such that the presence of the transportation means is notified to the periphery thereof, and includes an image projection means 11 configured to project an image onto the ground on the periphery of the transportation means 10; a memory unit 12 in which a plurality of images are stored; and a microcomputer 13 controlling the image projection means and the memory unit such that at least one image among the plurality of images is projected onto the ground on the periphery of the transportation means 100.

The transportation means 100 may be, for example, a car or other vehicle. A car or other vehicle refers to various types of vehicles designed to be used to transport people or cargo, such as a train, a ship, a boat, or an aircraft, in addition to an automobile 101, a motorcycle 102, and a bicycle 103, as shown in FIG. 5. In addition, it may refer to movable heavy equipment (fork lift 104, etc.).

The image projection means 11 may be a beam projector, logo projector, image light, etc., which is capable of outputting light or an image (shadow advertisement, floor advertisement, etc. including text, logo, etc.).

A beam projector is a device that projects slides or video image on a screen using light, and a logo projector is an LED promotional video device that projects images and text on various places, such as a wall or floor ceiling, by projecting light onto customized image glasses. The logo projector is produced and sold by QL Co., Ltd. in Korea (http://qlql.co.kr/).

The microcomputer 13 controls the image projection means 11 and the memory unit 12 so that one or more images of a plurality of images stored in the memory unit 12 are projected onto the ground on the periphery of the transportation means. One or more desired images may be extracted from the memory unit 12 to be projected when the beam projector is applied, although a function of the microcomputer 13 described above is not required, by using ImageGlass with letters, logos, etc. when the logo projector is applied to the situation notification apparatus 10.

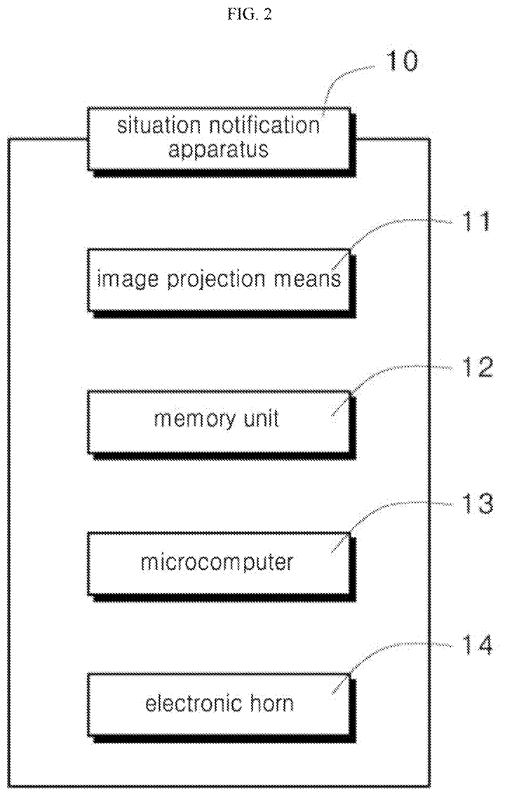

The situation notification apparatus 10 may further include an electronic horn 14, as shown in FIG. 2. In contrast to the situation notification apparatus 10 as shown in FIG. 1, which outputs only light or images (shadow advertisement, floor advertisement, etc. including text, logo, etc.), the situation notification apparatus 10 shown in FIG. 2 with an electronic horn 14, which is capable of outputting an electronic sound in addition to light or an image output, may output only an image, output images and electronic sounds simultaneously, or output only electronic sounds, depending on surrounding environments. The case where only the image is output is suitable for use in residential areas; the case where only the electronic sound is output is suitable for use on the road; and the case where images and electronic sounds are simultaneously output is suitable for use in cluttered and noisy places such as construction sites.

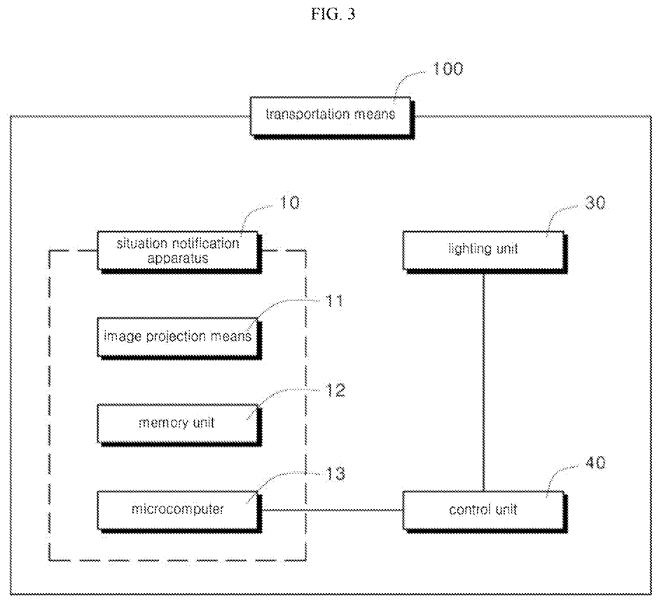

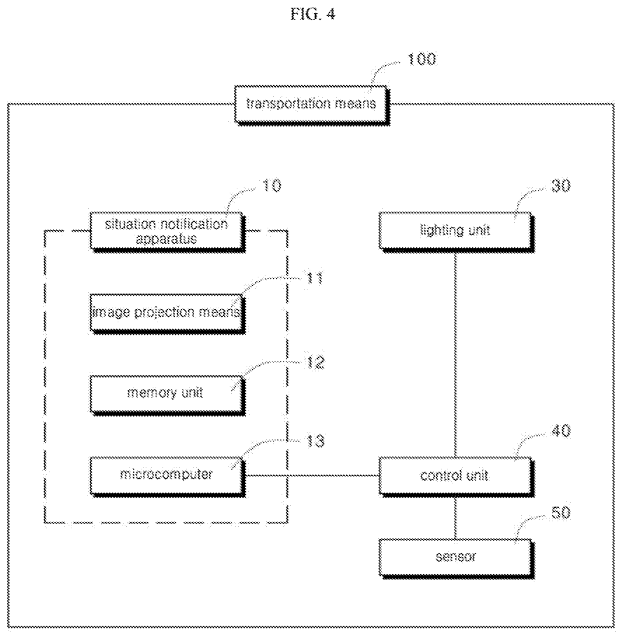

FIG. 3 is a block diagram showing a state in which the situation notification apparatus 10 shown in FIG. 1 is applied to the transportation means 100 including a control unit 40 capable of adjusting the brightness of the lighting unit 30; and FIG. 4 shows a state in which the situation notification apparatus 10 shown in FIG. 1 is applied to a transportation means 100 including a control unit 40 capable of adjusting the brightness of the lighting unit 30 and a sensor 50 detecting a surrounding object. When the transportation means 100 is a vehicle, the lighting unit 30 of the transportation means 100 may be, for example, a headlight, taillight, brake light, etc. of the vehicle. In the case that a car driver moves through a residential area at night and encounters a pedestrian, when the driver operates the image projection means 11 in silent mode to alert the pedestrian to step aside, the visibility of the image may be reduced due to the brightness of the headlights. Therefore, in the case that the lighting unit 30 such as a headlight is operated, the control unit 40 may improve the visibility of the image by adjusting the brightness of the lighting unit 30 when the image projection means 11 is operated. Meanwhile, the transportation means 100 may be equipped with an illumination sensor. Herein, in the case that the car moves the residential area during the day, when operating the image projection means 11 to alert the pedestrian to step aside, the visibility of the image may be increased by adjusting the output state of the image projection means 11 according to the signal of the illumination sensor.

When the sensor 50 is additionally installed in the transportation means 100 as shown in FIG. 4, the sensor 50 is installed at regular intervals around the body of the transportation means 100 to detect surrounding objects. When the driver of the transportation means 100 operates the image projection means 11, the sensor 50 is operated to detect objects around the transportation means 100.

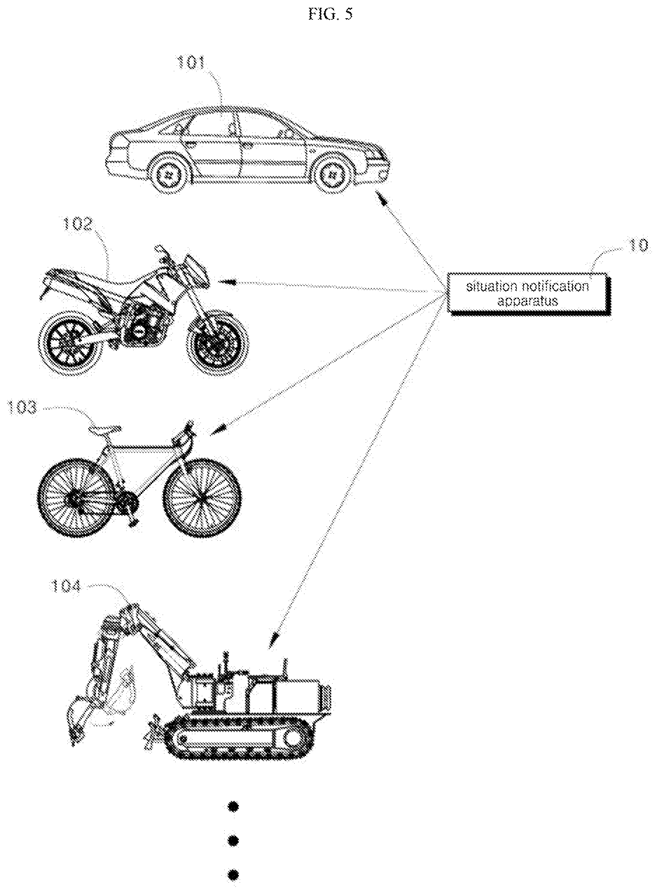

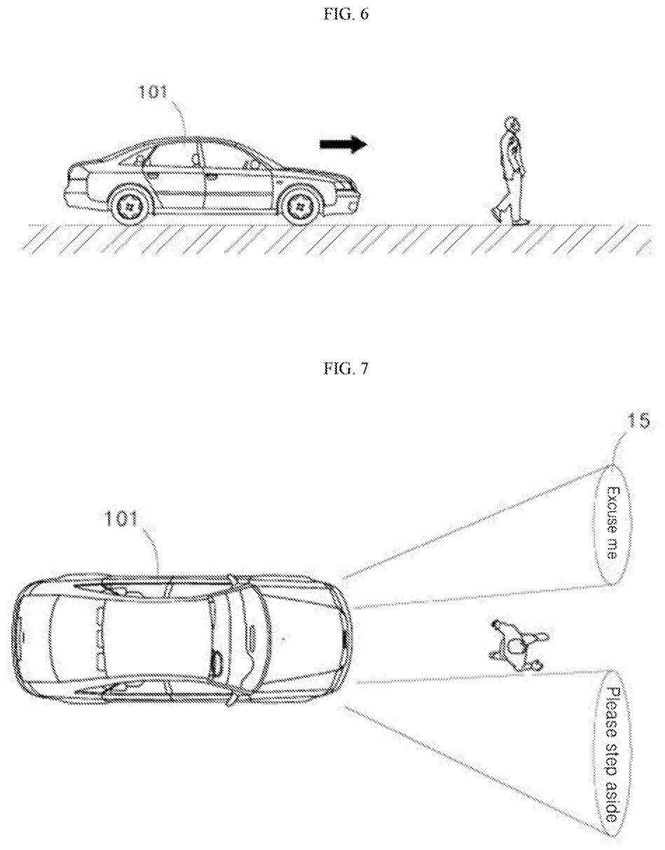

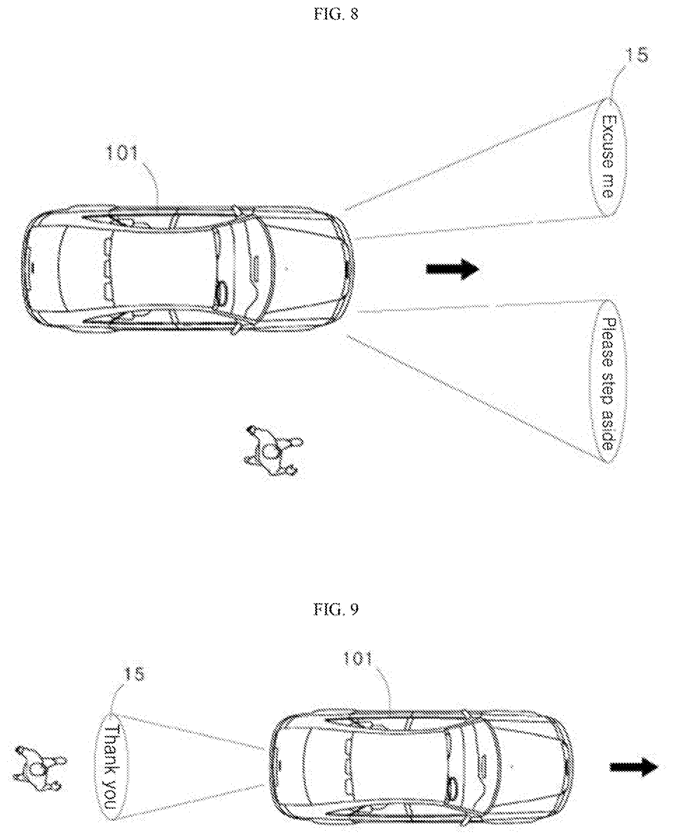

Referring to FIGS. 6 to 9, when the automobile 101 encounters a pedestrian while moving in a residential area, it is noted that there is a situation in which the use of the vehicle horn is very disrespectful to neighbors, so the driver waits for the pedestrian to be aware of the automobile 101 without using the electronic horn function. The image projection means 11 according to the present invention may allow the pedestrian to quickly be aware of the automobile 101 without the electronic horn. Of course, the driver may politely request the pedestrian to step aside. FIG. 6 shows a situation in which the automobile 101 meets a pedestrian while moving in a residential area. Herein, the driver of the automobile 101 politely alerts the pedestrian to step aside without surprising him/her, as shown in FIG. 7. Referring to FIG. 7, the situation notification apparatus 10 is installed in each of both sides of the front portion of the automobile 101, so that an image 15 may be projected onto both sides with the pedestrian in between to alert him/her to step aside. The pedestrian may be aware that the automobile 101 is proximity to him/her by looking at a step aside-indicating image on both sides in front of him/her. Therefore, as shown in FIG. 8, the pedestrian steps out of the advancing direction of the automobile 101 to allow the automobile 101 to pass by. Then, the driver of the automobile 101 may express his/her thanks to the pedestrian by operating the situation notification apparatus 10 installed at the rear of the car. Such a process may be performed automatically, in part, by the sensor 50. For example, in the case that image projection is performed in the situation notification apparatus installed at a front portion of the automobile 101, when the object is tracked around the body of the vehicle and then detected from the rear side of the body through the sensor 50, the process of operating the situation notification apparatus installed at the rear portion may be automated through the control unit 40 and the microcomputer 13. Meanwhile, it is possible to perform partial automation by applying a timer without the sensor 50. For example, the partial automation is possible by causing the situation notification apparatus installed at the rear portion of the automobile 101 to be operated, after the timer has elapsed a prescribed time when the driver operates the situation notification apparatus installed at the front portion of the automobile 101.

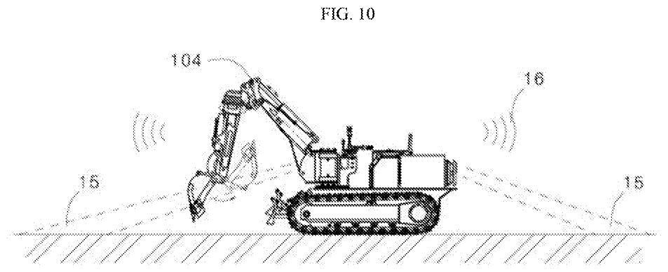

Considering FIG. 10, it is possible to prevent a negligent accident by making the surrounding persons be aware that the fork lift 104 is working. The situation notification apparatus according to the present invention may be applied to the fork lift 104 to simultaneously output light or an image 15 and an electronic sound 16 around the work site, thereby preventing the negligent accident.

Meanwhile, when the situation notification apparatus 10 is applied to a ship, the situation notification apparatus 10 may be linked to a system in which ship operation information is stored, which is useful when informing the departure time. That is, when the current time point is 20 minutes before departure according to the operation information, passengers may be informed of the departure time by projecting the image “20 minutes before departure” with the situation notification apparatus 10 on the bottom of a certain place of the port.

In addition, the vehicle to which the situation notification apparatus 10 is provided to output only an image, output images and electronic sounds simultaneously, output only electronic sounds, or output images, electronic sounds, and emergency lights simultaneously, depending on surrounding environments.

As described above, although the present invention has been described by limited embodiments and drawings, the present invention is not limited to the above embodiments, and those skilled in the art to which the present invention pertains may vary from these descriptions. Modifications and modifications are possible.

Therefore, the scope of the present invention should not be limited to the described embodiments, but should be defined not only by the following claims, but also by the claims and equivalents.

1. A situation notification apparatus, which is mounted in a transportation means to emit light such that the presence of the transportation means is notified to the periphery thereof, the apparatus comprising:
an image projection means configured to project an image onto the ground on the periphery of the transportation means;
a memory unit in which a plurality of images are stored; and
a microcomputer controlling the image projection means and the memory unit such that at least one image among the plurality of images is projected onto the ground on the periphery of the transportation means.

2. A situation notification apparatus, which is mounted in a transportation means to provide electronic sound, light, or electronic sound and light such that the presence of the transportation means is notified to the periphery thereof, the apparatus comprising:
an electronic horn generating the electronic sound on the periphery of the transportation means;
an image projection means configured to project an image onto the ground on the periphery of the transportation means;
a memory unit in which a plurality of images are stored; and
a microcomputer controlling the image projection means and the memory unit such that at least one image among the plurality of images is projected onto the ground on the periphery of the transportation means or controlling the image projection means, the memory unit, and the electronic horn such that at least one image and the electronic sound are output.

3. A transportation means comprising:
a body of a transportation means;
at least one situation notification apparatus according claim 1 mounted on the body of the transportation means;
a lighting unit mounted in the body of the transportation means to emit light; and
a control unit controlling a brightness of the lighting unit, in order to secure noticeability and visibility of an image when the situation notification apparatus is operated.

4. The transportation means of claim 3, further comprising a sensor installed in all sides of the body to detect an object around the body,
wherein the situation notification apparatus is configured so that a front situation notification apparatus that allows the image to be projected in front of the body and a rear situation notification apparatus that allows the image to be projected behind the body are installed at front and rear portions of the body, respectively; and
the control unit tracks the object around the body through the sensor when image projection is performed by the front situation notification apparatus, and then operates the rear situation notification apparatus when the object is detected in the rear portion of the body.

5. A transportation means comprising:
a body of a transportation means;
at least one situation notification apparatus according claim 2 mounted on the body of the transportation means;
a lighting unit mounted in the body of the transportation means to emit light; and
a control unit controlling a brightness of the lighting unit, in order to secure noticeability and visibility of an image when the situation notification apparatus is operated.

6. The transportation means of claim 5, further comprising a sensor installed in all sides of the body to detect an object around the body,
wherein the situation notification apparatus is configured so that a front situation notification apparatus that allows the image to be projected in front of the body and a rear situation notification apparatus that allows the image to be projected behind the body are installed at front and rear portions of the body, respectively; and
the control unit tracks the object around the body through the sensor when image projection is performed by the front situation notification apparatus, and then operates the rear situation notification apparatus when the object is detected in the rear portion of the body.
